(19) United States
(12) Patent Application Publication
(10) Pub. No.: US 2001/0007720 A1
(43) Pub. Date: Jul. 12, 2001

(54) ALUMINUM ALLOY BRAZING SHEET

(76) Inventors: NOBORU SOGA, TOKYO (JP); YOSHIHITO INABAYASHI, TOKYO (JP); HIROSHI KANO, TOKYO (JP); TAKEYOSHI DOKO, TOKYO (JP); NORIYUKI YAMADA, TOKYO (JP)

Correspondence Address: BIRCH STEWART KOLASCH & BIRCH, PO BOX 747, FALLS CHURCH, VA, 22040-0747, US

(21) Appl. No.: 09/021,443

(22) Filed: Feb. 10, 1998

(30) Foreign Application Priority Data
Feb. 10, 1997 (JP) 26431/1997

(51) Int. Cl. B32B 15/00; C22C 21/00; F28F 21/08

(52) U.S. Cl. 428/654; 165/134.1

(57) ABSTRACT

There is disclosed an aluminum alloy brazing sheet for constituting a fluid passage, which comprises an Al—Si-series filler alloy clad on one or both surfaces of an aluminum alloy core material comprising 0.3 to 1.5 wt % of Cu and 0.03 to 0.3 wt % of Sn, the balance of the alloy being substantially Al. According to the aluminum alloy brazing sheet, the corrosion resistance can be remarkably improved, and therefore when the aluminum alloy brazing sheet is used for a heat exchanger, the life by the corrosion resistance of the heat exchanger can be improved strikingly, and therefore the industrial effect can be remarkably exhibited.

### FIELD OF THE INVENTION

The present invention relates to a brazing sheet, made of an aluminum alloy, that is excellent in corrosion resistance, for use in heat exchangers of automobiles and heat exchangers in various industries.

### BACKGROUND OF THE INVENTION

In the production of complicated structures made of aluminum alloys, brazing is an effective means. Brazing processes include the vacuum brazing process (hereinafter referred to as the VB process), wherein no flux is required in brazing, and the controlled-atmosphere brazing process (hereinafter referred to as the NB process), wherein, after a non-corrosive flux is applied, the objective to be brazed is heated in an oxygen reducing atmosphere. Standards of aluminum alloy of brazing sheet for a heat exchanger are shown in JIS Z 3263 and JIS H 4000. For a brazing sheet for heat exchangers, generally, as a core alloy, JIS 3003 (a typical example is an Al alloy: Cu-0.15 wt %, Mn-1.1 wt %, Al-remainder), JIS 3005 (a typical example is an Al alloy: Mn 1.1 wt %, Mg-0.4 wt %, Al-remainder), or JIS 3105 (a typical example is an Al alloy: Mn-0.6 wt %, Mg-0.6 wt %, Al-remainder) is used, and as a cladding material, JIS 4004 (a typical example is an Al alloy: Si-10 wt %, Mg-1.5 wt %, Al-remainder) or JIS 4104 (a typical example is an Al alloy: Si-10 wt %, Mg-1.2 wt %, Bi-0.1 wt %, Al-remainder) is used in the VB process, and JIS 4015 (a typical example is an Al alloy: Si-10 wt %, Al-remainder) or JIS 4343 (a typical example is an Al alloy: Si-7.5 wt %, Al-remainder) is used in the NB process. Further, brazing sheets usually have a thickness of 0.2 to 1.2 mm, and a filler alloy is being clad on one or both surfaces and amounts to 5 to 30% per surface.

As heat exchangers of aluminum alloys having a hollow structure manufactured by using such brazing sheets, drone-cup-type evaporators, oil coolers, radiators, etc., can be enumerated.

For example, as is shown in FIG. 4, a drone-cup-type evaporator 8 is assembled by forming each brazing sheet into a member 1, shown in FIGS. 1 and 2, stacking such members 1 as shown in FIG. 4, placing each corrugated fin 2 between the stacked members 1, and arranging side plates 5, 5′, a refrigerant inlet pipe 6, and a refrigerant outlet pipe 7, which are brazed by the VB process or the NB process, with the heating carried out at about 873 K.

As is shown in FIG. 5, in a radiator, on the other hand, each corrugated fin 10 is integrally formed between a plurality of flattened tubes 9 (refrigerant passages), the opposite ends of the flattened tubes 9 are opened to spaces formed by a header 11 and a tank 12, a high-temperature refrigerant is passed to the space on one side of the tank 12 from the space on the other tank side through the flattened tubes 9, the heat of the refrigerant is exchanged at the fins 10 and the tubes 9, and the refrigerant, whose temperature is thus lowered, is circulated again.

In such a heat exchanger, as described above, a brazing sheet is used for the member 1, the flattened tubes 9 and so on. Thus, in the heat exchanger, the brazing sheet comprising as the core alloy, for example, JIS 3003 alloy is used; as a lining material that is placed inside of the core alloy and is exposed to the refrigerant at all times, JIS 7072 alloy is used; and outside of the core alloy clad with a filler alloy, such as JIS 4045 alloy; is generally used. This and other members that include corrugated fins and the like, are assembled into each core, the core is coated with a fluoride-series flux, and they are brazed by the NB process at 873 K.

As automobiles are made light in weight, it is required that the plate materials used in these heat exchangers be made thin. The environments in which automobiles are used, on the other hand, vary widely, and Cl⁻, for example, from sea salt particles and snow-melting salts, and corrosive substances, such as SOₓ from exhaust gases, adhere to heat exchangers. In particular, in the case of an evaporator, the operation and stoppage of the air conditioner bring the evaporator to a dried state and a wet state repeatedly, to concentrate the corrosive substances, and therefore the material of the evaporator, even if it is chromated, is required to be a high-corrosion-resistant material. Particularly, if vacuum brazing is carried out, in the case of a drone-cup-type heat exchanger having no sacrificial layer owing to the restriction of the brazing step, the corrosion resistance of the core alloy is the most important property required for the material. Therefore, the development of brazing sheets having corrosion resistance is desired earnestly, and various investigations are being made in this regard.

If conventional core alloys (JIS 3003, 3005, and 3105) are used, the amount of Cu in the core alloys is small, and when the brazing is carried out, Cu diffuses into the filler alloy side. Therefore, electrical potential less arises between the filler alloy and the core alloy, the filler alloy cannot prevent the corrosion of the core alloy in a sacrificial manner, and when pitting corrosion occurs in the core alloy, the corrosion quickly pierces the core alloy, which is a problem. Further, there is a problem that the Cu diffused into the filler alloy layer acts as a cathode, and that site serves as a corrosion starting point, to facilitate corrosion. Further, when a large amount of Cu is added to the core alloy, Cu, Mg, and the like deposit at grain boundaries, and intergranular corrosion is likely to occur at those parts and the Cu depleted layers near the grain boundaries. Further, even when the amount of Cu is increased in the core alloy, in an attempt to make a potential difference between the core alloy and the filler alloy, the Cu diffuses into the filler alloy layer, to make the electrical potential at the filler alloy surface noble. Therefore, the potential difference between the filler alloy and the core alloy is not very increased, and on the contrary the self-corrosion resistance of the core alloy is deteriorated, which is a problem.

### SUMMARY OF THE INVENTION

An object of the present invention is to provide an aluminum alloy brazing sheet which is much improved in corrosion resistance.

Other and further objects, features, and advantages of the invention will appear more fully from the following description, taken in connection with the accompanying drawings.

### BRIEF DESCRIPTION OF THE DRAWINGS

FIG. 1 is a plane view showing a molded member for drone-cup evaporators.

FIG. 2 is a cross-sectional view taken along the line B-B′ of FIG. 1.

FIG. 3 is a cross-sectional enlarged view of a part A of the member shown in FIG. 2, showing the structure of a conventional Al alloy brazing sheet in cross section, with C-D in FIG. 3 corresponding to C-D in FIG. 2.

FIG. 4 is an illustrative view showing schematically, in cross section, an example of a heat exchanger (drone-cup evaporator), with C-D in FIG. 4 corresponding to C-D in FIGS. 2 and 3.

FIG. 5 is a schematic view of a heat exchanger (radiator).

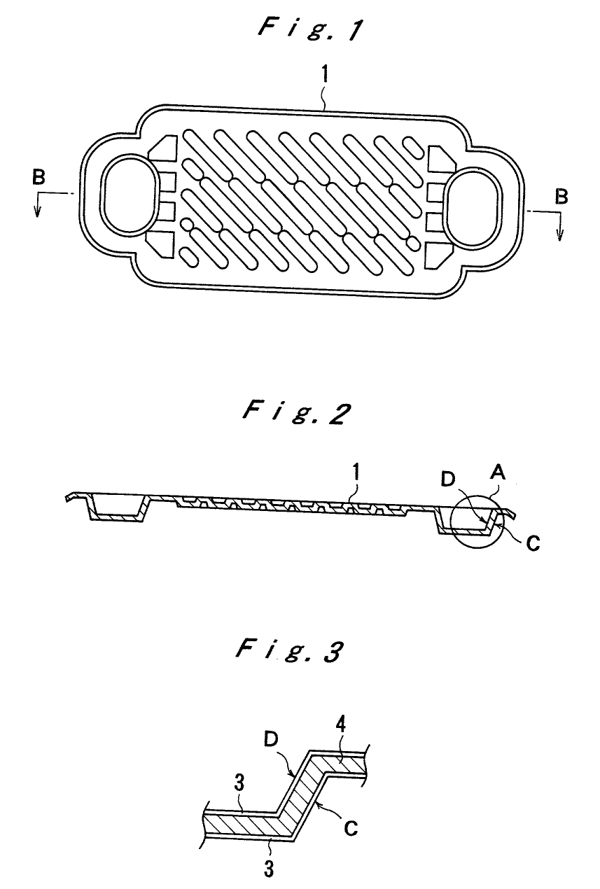

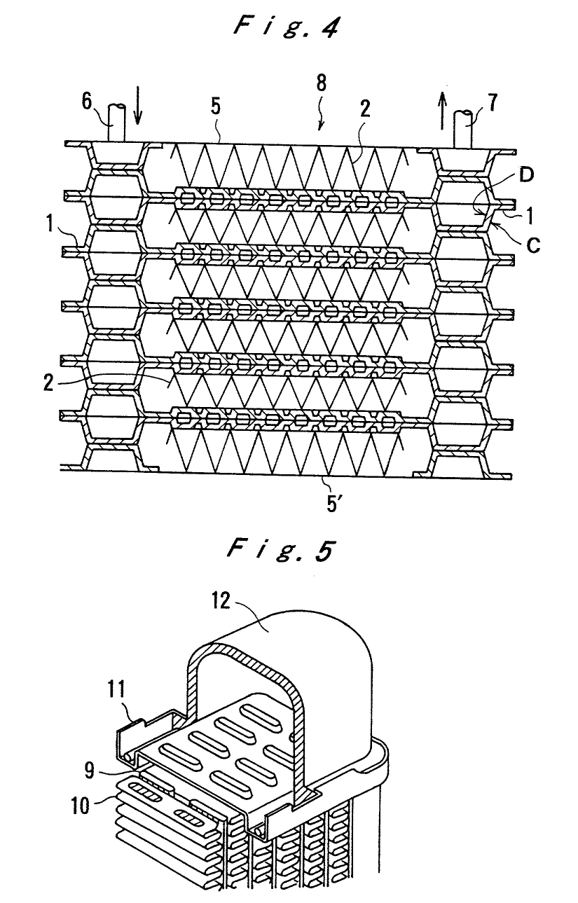

### DETAILED DESCRIPTION OF THE INVENTION

The present invention provides:

(1) An aluminum alloy brazing sheet for constituting a fluid passage, which comprises an Al—Si-series filler alloy clad on one or both surfaces of an aluminum alloy core material comprising essentially 0.3 to 1.5 wt % of Cu and 0.03 to 0.3 wt % of Sn, the balance of the alloy being substantially Al.

(2) The aluminum alloy brazing sheet for constituting a fluid passage in the above (1), wherein the Al—Si-series filler alloy contains Sn in an amount of 0.03 to 0.3 wt %.

(3) The aluminum alloy brazing sheet for constituting a fluid passage in the above (1), wherein the aluminum alloy core material contains Cu in an amount of 0.5 to 1.0 wt %.

(4) The aluminum alloy brazing sheet for constituting a fluid passage in the above (1), wherein the Al—Si-series filler alloy does not contain Sn.

(5) The aluminum alloy brazing sheet for constituting a fluid passage in the above (1), wherein the filler alloy is clad on one or both surface of the core alloy, with the clad ratio in the range of 5 to 30% for the whole plate thickness.

(6) The aluminum alloy brazing sheet for constituting a fluid passage in the above (1), wherein a final thickness of the aluminum alloy brazing sheet is 0.2 to 1.2 mm.

(7) The aluminum alloy brazing sheet for constituting a fluid passage in the above (1), which is used for at least one of the material selected from the group consisting of an evaporator plate material, a radiator tube material, a header plate material and a tank material.

(8) An aluminum alloy brazing sheet for constituting a fluid passage, which comprises an Al—Si-series filler alloy clad on one or both surfaces of an aluminum alloy core material comprising Cu in an amount of 0.3 to 1.5 wt %, Sn in an amount of 0.03 to 0.3 wt %, and at least one element selected from the group consisting of Si in an amount of 1.2 wt % or less, Fe in an amount of 2.0 wt % or less, Mn in an amount of 2.0 wt % or less, Ti in an amount of 0.3 wt % or less, Mg in an amount of 1.0 wt % or less, Cr in an amount of 0.5 wt % or less, Zr in an amount of 0.5 wt % or less, and Zn in an amount of 2.0 wt % or less, the balance of the alloy being substantially Al.

(9) The aluminum alloy brazing sheet for constituting a fluid passage in the above (8), wherein the Al—Si-series filler alloy contains Sn in an amount of 0.03 to 0.3 wt %.

(10) The aluminum alloy brazing sheet for constituting a fluid passage in the above (8), wherein the aluminum alloy core material contains Cu in an amount of 0.5 to 1.0 wt %.

(11) The aluminum alloy brazing sheet for constituting a fluid passage in the above (8), wherein the Al—Si-series filler alloy does not contain Sn.

(12) The aluminum alloy brazing sheet for constituting a fluid passage in the above (8), wherein the aluminum alloy core material contains at least one of Si in an amount of 0.05 to 1.0 wt %, Fe in an amount of 0.05 to 1.0 wt %, Mn in an amount of 0.4 to 1.5 wt %, Ti in an amount of 0.1 to 0.2 wt %, Mg in an amount of 0.1 to 0.3 wt %, Cr in an amount of 0.05 to 0.25 wt %, Zr in an amount of 0.05 to 0.25 wt % and Zn in an amount of 0.1 to 1.0 wt %.

(13) The aluminum alloy brazing sheet for constituting a fluid passage in the above (8), wherein the filler alloy is clad on one or both surface of the core alloy, with the clad ratio in the range of 5 to 30% for the whole plate thickness.

(14) The aluminum alloy brazing sheet for constituting a fluid passage in the above (8), wherein a final thickness of the aluminum alloy brazing sheet is 0.2 to 1.2 mm.

(15) The aluminum alloy brazing sheet for constituting a fluid passage in the above (8), which is used for at least one of the material selected from the group consisting of an evaporator plate material, a radiator tube material, a header plate material and a tank material.

Hereinbelow, the present invention is described.

In the present invention the distribution of elements in a range from a filler alloy layer to a core alloy is controlled after heating for brazing, so as to improve the corrosion resistance. Through the reason of the improvement is not made clear in detail, it is assumed as follows:

Since Cu and Sn added to a core alloy diffuse into a filler alloy layer of the brazing sheet during heating for brazing, the composition of the filler alloy after brazing becomes significantly different from that of the filler alloy before brazing. As is stated above, the corrosion resistance of a filler alloy containing Cu is poor, but the inclusion of Sn along with Cu decreases corrosion starting points which act as a cathode and therefore improves the corrosion resistance of the filler alloy layer itself.

Further, since the Sn makes the electrical potential of the alloy less noble, the electrical potential of the filler alloy layer is made less noble than that of the core alloy, to the extent that it contributes to the corrosion resistance, so that the corrosion resistance of the brazing sheet is improved.

In addition, from the filler alloy layer toward the center of core alloy, a Cu concentration gradient is produced in about 100 μm in thickness from the filler alloy surface, due to the diffusion of Cu added to the core alloy to the filler alloy layer at the time of brazing, the concentration gradient produces a potential gradient in the material. Here, when Sn and Cu are simultaneously added to a core alloy, if the amount of Cu is small, the Sn acts greatly, to make the electrical potential less noble, whereas if the amount of Cu is large, the Sn brings about hardly any effect of lowering the electrical potential. In the case of the brazing sheet of the present invention containing Sn and Cu in the core alloy, the electrical potential between the filler alloy layer and the inside of the core alloy is large, and therefore the electrical gradient is also large. Thus, the filler alloy layer serves as an effective cathodic protection layer of the core alloy, to not allow the corrosion to be in the state of pitting corrosion, but to make the corrosion be in the state of surface corrosion, thereby improving the corrosion resistance.

Further, at the time of heating for brazing, Sn diffuses into grain boundaries of the core alloy. As is described above, a high concentration Cu core alloy permits Cu-series compounds to deposit at the grain boundaries, to make the difference of the electric potential thereof from that of the Cu-depleted layer in the grain boundaries increased, and therefore intergranular corrosion tends to occur, wherein less noble parts in the grain boundaries are preferentially corroded. Here, since the diffused Sn forms compounds with Cu in the grain boundaries, to make the electrical potential of the deposited product less noble, the potential difference between the Cu-series deposit and the parts adjacent to the grain boundaries is made small, to lower the intergranular corrosion susceptibility.

Incidentally, there is disclosed an aluminum alloy fin material that includes In, etc. as an essential component, an element such as Sn whose electric potential is less noble and Cu, for example, in JP-A-62-120455 (“JP-A” means unexamined Japanese publication). However, this is a fin material (bare material) in which Cu is used to increase its strength and Sn is used to make its electric potential less noble, and the fin material functions as sacrificial anode fin against a water pipe material composed of a brazing sheet. The present invention is basically different from that of the publication, in that the present invention is a high-corrosion-resistant material of the brazing sheet which occurs the above action on the refrigerant passage side.

The core alloy used in the present invention is first described.

Cu is required to make noble the electric potential of the core alloy after the brazing, to cause the filler alloy layer to be a cathodic corrosion preventive layer, as well as to improve the strength, and Cu is added in an amount of 0.3 to 1.5 wt %. If the amount of Cu is less than the lower limit value, the potential difference between the inside of the core alloy and the filler alloy layer cannot be made satisfactory. On the other hand, if the amount of Cu is more than the upper limit value, in addition to that the melting point of the core alloy is lowered greatly, the core alloy is made susceptible to intergranular corrosion, and the self-corrosion resistance of the core alloy is deteriorated. Therefore, the amount of Cu ranges from 0.3 to 1.5 wt %, preferably from 0.5 to 1.0 wt %, and more preferably 0.6 to 0.9 wt %.

As is described above, Sn is added because it diffuses uniformly in the direction of the thickness of the sheet, to make the electric potential of the filler alloy layer surface less noble, to increase the difference of the electric potential thereof from that of the core alloy, as well as to make the electric potential of the filler alloy eutectic sites less noble, to decrease the starting points of corrosion and to decrease the potential difference between the grain boundaries and the parts near the grain boundaries in the core alloy, to reduce the susceptibility of the intergranular corrosion. The amount of Sn ranges from 0.03 to 0.3 wt %. If the added amount is less than 0.03 wt %, the effect is a little, while if the added amount is over 0.3 wt %, the cost increases, the production of the material becomes difficult because edge cracks occur during the hot rolling, and the self-corrosion resistance of the core alloy is lowered.

In one embodiment of the present invention the balance is substantially Al. As an alternative embodiment at least one of Si, Fe, Mn, Ti, Mg, Cr, Zr or Zn in a prescribed amount further can be included in the core alloy.

Si is added, if needed, in an amount of 1.2 wt % or less, to cause intermetallic compounds with Mn and/or Fe to deposit, to increase the strength. If the amount is less than 0.05 wt %, the effect of improving the strength is not satisfactory, while if the amount is over 1.0 wt %, the core alloy is likely to melt at the time of heating for brazing. Therefore, preferably the amount is 0.05 to 1.0 wt %.

Fe is added, if needed, in an amount of 2.0 wt % or less, in order to improve the strength. If the amount is over the upper limit value, corrosion starting points which act as a cathode in the core alloy increase, to deteriorate the corrosion resistance, and since the diameter of recrystallized particles of the core alloy is made small, the filler alloy diffuses to the core alloy in an abnormal manner, to lower the brazing property. Preferably the amount is 0.05 to 0.1 wt %.

Mn is added, as required, in an amount of 2.0 wt % or less, in order to improve the strength and to prevent the filler alloy from diffusing. If the amount is over the upper limit value, the amount of the diffusion of the filler alloy into the core alloy during the heating for brazing increases, and hence the brazing property and the corrosion resistance are lowered. For this reason the range of the amount is 2.0 wt % or less, and preferably 0.4 to 1.5 wt %. If the diffusion of the solder (filler alloy) is prevented, it is particularly recommended to add Mn, because the corrosion resistance is improved.

Ti is added, as required, in an amount of 0.3 wt % or less, in order to make the ingot structure very fine and to improve the corrosion resistance. If the added amount of Ti is over 0.3 wt %, the production of the material becomes difficult. If added, preferably Ti is added in an amount of about 0.1 to 0.2 wt %.

When the VB process is used, Mg is added, as required, in an amount of 1.0 wt % or less, in order to improve the strength. If the added amount of Mg is less than 0.05 wt %, the effect of improving the strength is little, while if the added amount of Ti is over the upper limit value, the amount of the diffusion of the filler alloy into the core alloy during the heating for brazing increases, to lower the brazing property and the corrosion resistance. Therefore the range of the amount is preferably 0.05 to 1.0 wt %, more preferably 0.1 to 0.5 wt %. In the case of materials that are used in the NB process, since the brazing property is lowered, Mg is desirably not added, or if it is added, the amount is desirably 0.3 wt % at most.

Since Cr and Zr have an effect to make the crystal grains very fine and to increase the strength, they are added, as desired, in an amount of 0.5 wt % or less. However if the amount is less than 0.05 wt %, the effect to improve the strength is not satisfactory, while if the amount is over 0.25 wt %, the casting ability is retarded, and therefore desirably the amount is 0.05 to 0.25 wt %.

Zn is added, as required, in an amount of 2.0 wt % or less, in order to increase the strength, because it forms a compound with Cu. If the amount is over 2.0 wt %, the electric potential of the matrix in which Zn is present as solid solution is made less noble, and therefore the effect of the addition of Cu is canceled. Further, since Zn lowers the self-corrosion resistance of the alloy, to reduce the above effect of Sn, desirably Zn is not added. When Zn is added, preferably the amount is 0.1 to 1.0 wt %.

As other unavoidable impurities, Bi, B, Ca, In, Ni, Li, and the like can be taken into account, and the amounts thereof are preferably 0.05 wt % or less, respectively, in view of the corrosion resistance and the casting ability.

Now the filler alloy used in the present invention is described.

The filler alloy usable in the present invention is used an Al—Si-series filler alloy. The Al—Si-series filler alloy includes the filler alloy which uses an Al—Si-Mg-series alloy (i.e. JIS 4004 alloy, JIS 4104 alloy, and the like), an Al—Si-series alloy (i.e. JIS 4045 alloy, JIS 4343 alloy, and the like) and the other alloy containing Al and Si.

As the filler alloy used in the present invention, an Al—Si—Mg-series alloy, including JIS 4004 alloy, JIS 4104 alloy, and the like, is used in the case of the VB process, and an Al—Si-series alloy, including JIS 4045 alloy, JIS 4343 alloy, and the like, is used in the case of the NB process. These usual alloys may of course be used, and desirably Sn is added, to increase the corrosion resistance further. Sn makes the electric potential of the filler alloy further less noble and decreases the corrosion starting points of the filler alloy. For that purpose, the amount of Sn is desirably 0.03 to 0.3 wt %. If the added amount is less than 0.03 wt %, the effect is little, whereas if the added amount is over 0.3 wt %, the cost is increased, edge cracks occur during the hot rolling, to make the production of the material difficult, and the self-corrosion resistance is lowered. Other less noble elements including In, Zn, etc., may be expected to have the same effect, but the influence on the corrosion resistance is inferior to that of Sn. The filler alloy is clad on one or both surfaces of the core alloy, with the clad ratio being in the range of 5 to 30% for the whole plate thickness.

Further, the method for producing the aluminum alloy brazing sheet according to the present invention can be carried out in the same way as conventional methods in a usual manner. Specifically, the prescribed Al alloy materials for the core alloy and the filler alloy are melted and cast into ingots, the ingots are subjected to a homogenizing treatment (soaking) and are rolled into a prescribed thickness as required, and they are put together, are hot-rolled, and then are cold-rolled (conducting annealing, if necessary), thereby producing the desired aluminum alloy brazing sheet. The final thickness is preferably 0.2 to 1.2 mm.

When the brazing sheet is used for an evaporator, generally the brazing sheet has a structure of a filler alloy/core alloy/filler alloy, whereas when the brazing sheet is used for a radiator or a heater, generally the brazing sheet has a structure of a filler alloy/core alloy/inner lining or a filler alloy/core alloy.

The brazing sheet of the present invention can be used as a material for the construction of a fluid passage of heat exchangers (e.g. evaporators, radiators, heaters, and oil coolers). Herein the term “a material for the construction” means, in the case of an evaporator, an evaporator plate material through which a flon gas, as a working refrigerant, is passed, or it means, in the case of a radiator, a radiator tube material, a header plate material, and a tank material, through respectively each of which a cooling water is passed. In either case, the material itself is required to have a high corrosion resistance, and a through-hole immediately means a failure of the product.

The heat exchanger utilizing the brazing sheet of the present invention is produced by brazing, and the brazing may be carried out by a conventionally used process, such as the VB process and the NB process. Since the heat at the time of brazing causes Sn and Cu to diffuse, the heating for brazing is essential in the present invention. In the present invention, its remarkable effect is exhibited particularly in the VB process.

As is described above, in the brazing sheet of present invention corrosion resistance can be remarkably improved, and therefore when the aluminum alloy brazing sheet is used for a heat exchanger, the life by the corrosion resistance of the heat exchanger can be improved strikingly, and therefore the industrial advantages can be remarkably exhibited.

### EXAMPLES

Now, the present invention is described in detail based on Examples, but the present invention is not restricted to the following examples.

### Example 1

Each of the surfaces of each of the aluminum alloys for various core alloys shown in Table 1 was clad with an aluminum alloy (JIS 4104 alloy (Si-10 wt %, Mg-1.2 wt %, Bi-0.1 wt %; Al alloy)) as a filler alloy, in an amount of 15% per thickness, to produce each three-layer brazing sheet for an aluminum alloy tube material. The sheet thickness was 1.0 mm, the filler alloy layer thickness was 150 μm, and refining was conducted to give an O-material. Specifically, the core alloy was casted to have a thickness of 400 mm and was subjected to a homogenizing treatment at a temperature in the range of 450 to 600° C., each of the surfaces thereof was cut by 10 mm, previously prepared filler alloy plates (having a thickness that could give a product having the intended filler alloy layer thickness) were put on the surfaces, and they were hot-rolled. One that was cracked in the hot-rolling and could not give a product was designated as rolling property being bad (X). After each hot-rolled coil was obtained, usual steps (cold-rolling and annealing) were followed. A sample was cut out from each of the obtained three-layer brazing sheets and was subjected to vacuum brazing heating under a vacuum of 6.7×10⁻³ Pa at 873 K for 3 min, to obtain a test specimen.

The corrosion potential difference (in 5% NaCl) between the filler alloy surface of the test specimen and the position 300 μm away from the filler alloy surface thereof was found. The corrosion test (CASS test) of the test specimen was carried out with the other surface coated with a resin. 500 hours and 750 hours after the start of the test, the test specimen was taken out, and the corrosion product on the surface was removed, to evaluate the state of the corrosion of the material. The evaluation was carried out in such a way that the pitting depth at the maximum pitting part was measured under an optical microscope by the focal depth method. From each of these test specimens, JIS No. 5 TP (test piece) was prepared, and the tensile strength was measured. The results are shown in Table 1.

TABLE 1

| | | | | | | | | | | | | | | Corrosion Resistance | | | | |
|---|---|---|---|---|---|---|---|---|---|---|---|---|---|---|---|---|---|---|
| | | | | | | | | | | | | | | | Maximum | Maximum | | |
| | | | | | | | | | | | | | | | pittig | pittig | | |
| | | Composition of the core alloy (wt %) | | | | | | | | | | | Filler | Potential | depth | depth | Rolling | Tensile |
| | No. | Cu | Sn | Si | Fe | Mn | Ti | Mg | Cr | Zr | Zn | Al | alloy | difference | 500 hr | 750 hr | property | strength |
| Example of | 1 | 0.3 | 0.05 | 0.2 | 0.2 | 1.0 | — | — | — | — | — | balance | 4104 | 30 mv | 360 μm | 450 μm | ∘ | 126 MPa |
| the present | 2 | 0.3 | 0.1 | 0.1 | 0.2 | 1.0 | — | — | — | — | — | balance | 4104 | 37 mv | 340 μm | 430 μm | ∘ | 126 MPa |
| invention | 3 | 0.3 | 0.3 | 0.1 | 0.2 | 1.0 | — | — | — | — | — | balance | 4104 | 40 mv | 350 μm | 520 μm | ∘ | 127 MPa |
| | 4 | 0.3 | 0.1 | 0.1 | 0.2 | 1.0 | — | 0.1 | — | — | — | balance | 4104 | 37 mv | 350 μm | 460 μm | ∘ | 130 MPa |
| | 5 | 0.3 | 0.3 | 0.1 | 0.2 | 1.0 | — | 0.1 | — | — | — | balance | 4104 | 40 mv | 360 μm | 530 μm | ∘ | 128 MPa |
| | 6 | 0.3 | 0.1 | 0.1 | 0.2 | 1.0 | — | 0.3 | — | — | — | balance | 4104 | 37 mv | 360 μm | 460 μm | ∘ | 133 MPa |
| | 7 | 0.3 | 0.3 | 0.1 | 0.2 | 1.0 | — | 0.3 | — | — | — | balance | 4104 | 40 mv | 370 μm | 540 μm | ∘ | 132 MPa |
| | 8 | 0.3 | 0.1 | 0.1 | 0.2 | 1.0 | 0.2 | — | — | — | — | balance | 4104 | 37 mv | 320 μm | 400 μm | ∘ | 127 MPa |
| | 9 | 0.3 | 0.3 | 0.1 | 0.2 | 1.0 | 0.2 | — | — | — | — | balance | 4104 | 40 mv | 330 μm | 480 μm | ∘ | 127 MPa |
| | 10 | 0.3 | 0.1 | 0.1 | 0.2 | 1.0 | 0.1 | 0.2 | — | — | — | balance | 4104 | 37 mv | 330 μm | 480 μm | ∘ | 128 MPa |
| Comparative | 11 | — | — | 0.1 | 0.1 | 1.0 | — | — | — | — | — | balance | 4104 | 0 mv | 850 μm | Pierce | ∘ | 115 MPa |
| Example | 12 | — | 0.7 | 0.1 | 0.2 | 1.0 | — | — | — | — | — | balance | 4104 | — | — | — | x | — |
| | 13 | 0.3 | — | 0.2 | 0.2 | 1.0 | — | — | — | — | — | balance | 4104 | 15 mv | Pierce | Pierce | ∘ | 125 MPa |
| | 14 | 0.3 | 0.7 | 0.2 | 0.2 | 1.0 | — | — | — | — | — | balance | 4104 | — | — | — | x | — |
| | 15 | 0.7 | — | 0.1 | 0.15 | 1.0 | — | — | — | — | — | balance | 4104 | 25 mv | Pierce | Pierce | ∘ | 150 MPa |
| | 16 | 0.3 | — | 0.1 | 0.2 | 1.0 | — | 0.1 | — | — | — | balance | 4104 | 15 mv | Pierce | Pierce | ∘ | 130 MPa |
| | 17 | 0.3 | — | 0.2 | 0.2 | 1.0 | 0.2 | — | — | — | — | balance | 4104 | 15 mv | 800 μm | Pierce | ∘ | 127 MPa |
| Conventional | 18 | 0.15 | — | 0.1 | 0.1 | 1.0 | — | — | — | — | — | balance | 4104 | 10 mv | Pierce | Pierce | ∘ | 120 MPa |
| Example | 19 | 0.15 | — | 0.2 | 0.2 | 1.0 | — | 0.1 | — | — | — | balance | 4104 | 10 mv | Pierce | Pierce | ∘ | 123 MPa |

As is apparent from the results shown in Table 1, in comparing the brazing sheets of the present invention with Comparative Examples and Conventional Examples, in the brazing sheets of the present invention, since the potential difference between the inside of the core alloy and the filler alloy surface is satisfactory, the corrosion resistance is excellent, and the rolling property and the strength are satisfactory.

### Example 2

Each of the surfaces of each of the aluminum alloys for various core alloys shown in Table 2 was clad with an aluminum alloy (JIS 4104 alloy (Si-10 wt %, Mg-1.2 wt %, Bi-0.1 wt %; Al alloy) or 4104 alloy to which Sn had been added) for a filler alloy, in an amount of 20% per thickness, to produce each three-layer brazing sheet for an aluminum alloy tube material. The sheet thickness was 0.4 mm, the filler alloy layer thickness was 80 μm, and the refining was conducted to give an O-material. Specifically, the core alloy was casted to have a thickness of 400 mm and was subjected to a homogenizing treatment at a temperature in the range of 450 to 600° C., each of the surfaces thereof was cut by 10 mm, previously prepared filler alloy plates (having a thickness that could give a product having the intended filler alloy layer thickness) were put on the surfaces, and they were hot-rolled. One that was cracked in the hot-rolling and could not give a product was designated as rolling property being bad (X). After each hot-rolled coil was obtained, usual steps (cold-rolling and annealing) were followed. A sample was cut out from each of the obtained three-layer brazing sheets and was subjected to vacuum brazing heating under a vacuum of 6.7×10⁻³ Pa at 873 K for 3 min, to obtain a test specimen.

The corrosion potential difference (in 5% NaCl) between the filler alloy surface of the test specimen and the position 100 μm away from the filler alloy surface thereof was found. The corrosion test (CASS test) of the test specimen was carried out with the other surface coated with a resin. 750 hours after the start of the test, the test specimen was taken out, and the corrosion product on the surface was removed, to evaluate the state of the corrosion of the material. The evaluation was carried out in such a way that the pitting depth at the maximum pitting part was measured under an optical microscope by the focal depth method. From each of these test specimens, JIS No. 5 TP was prepared, and the tensile strength was measured. The results are shown in Table 2.

TABLE 2

| | | | | | | | | | | | | | | Corrosion Resistance | | | |
|---|---|---|---|---|---|---|---|---|---|---|---|---|---|---|---|---|---|
| | | | | | | | | | | | | | | | Maximum | | |
| | | Composition of the core alloy (wt %) | | | | | | | | | | | Filler | Potential | pittig | Rolling | Tensile |
| | No | Cu | Sn | Si | Fe | Mn | Ti | Mg | Cr | Zr | Zn | Al | alloy | difference | depth | property | strength |
| Example | 20 | 0.7 | 0.06 | — | — | — | — | — | — | — | — | balance | 4104 | 48 mV | 110 μm | ∘ | 123 MPa |
| of the | 21 | 0.8 | 0.1 | — | — | — | — | — | — | — | — | balance | 4104 | 60 mV | 95 μm | ∘ | 135 MPa |
| present | 22 | 0.7 | 0.1 | 0.2 | 0.2 | — | — | — | — | — | — | balance | 4104 | 58 mV | 83 μm | ∘ | 135 MPa |
| invention | 23 | 0.7 | 0.1 | 0.2 | 0.2 | — | — | — | — | — | 2.0 | balance | 4104 | 53 mV | 96 μm | ∘ | 140 MPa |
| | 24 | 0.7 | 0.1 | 0.2 | 0.2 | — | — | 0.2 | 0.2 | 0.2 | — | balance | 4104 | 58 mV | 86 μm | ∘ | 142 MPa |
| | 25 | 0.8 | 0.05 | 0.2 | 0.2 | — | 0.1 | 0.2 | — | — | — | balance | 4104 | 55 mV | 85 μm | ∘ | 140 MPa |
| | 26 | 0.8 | 0.05 | 0.2 | 0.2 | — | 0.1 | 0.2 | 0.2 | 0.2 | 0.3 | balance | 4104 | 55 mV | 90 μm | ∘ | 147 MPa |
| | 27 | 0.8 | 0.1 | 0.2 | 0.2 | 0.4 | — | — | — | — | — | balance | 4104 | 60 mV | 80 μm | ∘ | 142 MPa |
| | 28 | 0.8 | 0.1 | 0.2 | 0.2 | 0.4 | — | 0.2 | 0.2 | 0.2 | — | balance | 4104 | 60 mV | 82 μm | ∘ | 147 MPa |
| | 29 | 0.8 | 0.06 | 0.4 | 0.4 | 0.8 | — | — | 0.2 | 0.2 | — | balance | 4104 | 55 mV | 82 μm | ∘ | 153 MPa |
| | 30 | 0.7 | 0.1 | 0.4 | 1.2 | 0.8 | — | — | 0.2 | — | — | balance | 4104 | 56 mV | 85 μm | ∘ | 155 MPa |
| | 31 | 1.2 | 0.1 | 0.4 | 0.4 | 0.8 | — | — | — | — | — | balance | 4104 | 65 mV | 78 μm | ∘ | 170 MPa |
| | 32 | 0.7 | 0.06 | 0.2 | 0.2 | 1.2 | — | — | — | — | — | balance | 4104 | 50 mV | 95 μm | ∘ | 158 MPa |
| | 33 | 0.8 | 0.1 | 0.4 | 0.4 | 0.8 | 0.1 | 0.2 | 0.2 | 0.2 | 0.3 | balance | 4104 | 58 mV | 75 μm | ∘ | 160 MPa |
| | 34 | 0.7 | 0.1 | 0.8 | 0.4 | 0.8 | 0.1 | — | — | 0.8 | — | balance | 4104 | 56 mV | 83 μm | ∘ | 143 MPa |
| | 35 | 0.8 | 0.2 | 0.4 | 0.4 | 0.8 | 0.1 | 0.2 | 0.2 | 0.2 | 0.3 | balance | 4104 | 64 mV | 70 μm | ∘ | 160 MPa |
| | 36 | 0.4 | 0.05 | 0.4 | 0.4 | 0.8 | 0.1 | 0.2 | 0.2 | — | — | balance | 4104 | 40 mV | 150 μm | ∘ | 130 MPa |
| | 37 | 0.8 | 0.1 | — | — | — | — | — | — | — | — | balance | 4104 + 0.1 | 70 mV | 80 μm | ∘ | 135 MPa |
| | | | | | | | | | | | | | wt % Sn | | | | |
| | 38 | 0.8 | 0.1 | 0.4 | 0.4 | 0.8 | 0.1 | 0.2 | — | — | — | balance | 4104 + 0.1 | 72 mV | 65 μm | ∘ | 152 MPa |
| | | | | | | | | | | | | | wt % Sn | | | | |
| | 39 | 0.8 | 0.1 | 0.4 | 0.4 | 0.8 | 0.1 | 0.2 | — | — | — | balance | 4104 + 0.2 | 77 mV | 65 μm | ∘ | 152 MPa |
| | | | | | | | | | | | | | wt % Sn | | | | |
| Comparative | 40 | 0.8 | — | — | — | — | — | — | — | — | — | balance | 4104 | 32 mV | Pierce | ∘ | 135 MPa |
| Example | 41 | 0.8 | — | 0.4 | 0.4 | 0.8 | 0.1 | 0.2 | — | — | — | balance | 4104 | 32 mV | Pierce | ∘ | 150 MPa |
| | 42 | 0.25 | 0.1 | — | — | — | — | — | — | — | — | balance | 4104 | 14 mV | Pierce | ∘ | 105 MPa |
| | 43 | 1.7 | 0.1 | — | — | — | — | — | — | — | — | balance | 4104 | 42 mV | Pierce | ∘ | 165 MPa |
| | 44 | 0.8 | 0.01 | 0.4 | 0.4 | 0.8 | 0.1 | 0.2 | — | — | — | balance | 4104 | 35 mV | Pierce | ∘ | 150 MPa |
| | 45 | 0.8 | 0.4 | 0.2 | 0.2 | 0.8 | 0.2 | — | — | — | — | balance | 4104 | — | — | x | — |
| | 46 | 0.8 | 0.1 | 0.2 | 0.2 | 0.8 | 0.2 | — | — | — | — | balance | 4104 + 0.4 | — | — | x | — |
| | | | | | | | | | | | | | wt % Sn | | | | |
| Conventional | 47 | 0.15 | — | 0.2 | 0.2 | 0.8 | 0.2 | — | — | — | — | balance | 4104 | 14 mV | Pierce | ∘ | 120 MPa |
| Example | 48 | 0.3 | — | 0.2 | 0.2 | 0.8 | 0.2 | — | — | — | — | balance | 4104 | 18 mV | Pierce | ∘ | 130 MPa |

(Note) —: No evaluation because a product could not given

As is apparent from the results shown in Table 2, in comparing the brazing sheets of the present invention with Comparative Examples and Conventional Examples, in the brazing sheets of the present invention, since the potential difference between the inside of the core alloy and the filler alloy surface is satisfactory, the corrosion resistance is excellent, and the rolling property and the strength are satisfactory.

### Example 3

Each of the aluminum alloys for various core alloys shown in Table 3, an aluminum alloy (JIS 4045 alloy (Si-10 wt %; Al alloy) or 4045 alloy to which Sn had been added) for filler alloy, and an aluminum alloy (Zn-3 wt %; Al alloy) for inner lining were combined, to produce each three-layer brazing sheet for an aluminum alloy tube material. The sheet thickness was 0.2 mm, the filler alloy layer thickness was 30 μm, the inner lining material thickness was 30 μm, and the refining was conducted to give an H14-material. Specifically, the core alloy was casted to have a thickness of 400 mm and was subjected to a homogenizing treatment at a temperature in the range of 450 to 600° C., each of the surfaces thereof was cut by 10 mm, previously prepared filler alloy plates (having a thickness that could give a product having the intended filler alloy layer thickness) were put on the surfaces, and they were hot-rolled. One that was cracked in the hot-rolling and could not give a product was designated as rolling property being bad (X). After each hot-rolled coil was obtained, usual steps (cold-rolling and annealing) were followed. A sample was cut out from each of the obtained three-layer brazing sheets, it was coated with a flux, in an amount of 10 g/cm², and it was subjected to brazing heating in a nitrogen gas atmosphere at 873 K for 3 min, to obtain a test specimen.

The corrosion potential difference (in 5% NaCl) between the filler alloy surface of the test specimen and the position 50 μm away from the filler alloy surface thereof was found. The corrosion test (CASS test) of the test specimen was carried out with the other surface coated with a resin. 750 hours after the start of the test, the test specimen was taken out, and the corrosion product on the surface was removed, to evaluate the state of the corrosion of the material. The evaluation was carried out in such a way that the pitting depth at the maximum pitting part was measured under an optical microscope by the focal depth method. From each of these test specimens, JIS No. 5 TP was prepared, and the tensile strength was measured. The results are shown in Table 3.

TABLE 3

| | | | | | | | | | | | | | | Corrosion Resistance | | | |
|---|---|---|---|---|---|---|---|---|---|---|---|---|---|---|---|---|---|
| | | | | | | | | | | | | | | | Maximum | | |
| | | Composition of the core alloy (wt %) | | | | | | | | | | | Filler | Potential | pittig | Rolling | Tensile |
| | No | Cu | Sn | Si | Fe | Mn | Ti | Mg | Cr | Zr | Zn | Al | alloy | difference | depth | property | strength |
| Example | 49 | 0.7 | 0.06 | — | — | — | — | — | — | — | — | balance | 4045 | 44 mV | 55 μm | ∘ | 123 MPa |
| of the | 50 | 0.8 | 0.1 | — | — | — | — | — | — | — | — | balance | 4045 | 57 mV | 50 μm | ∘ | 135 MPa |
| present | 51 | 0.7 | 0.1 | 0.2 | 0.2 | — | — | — | — | — | — | balance | 4045 | 55 mV | 48 μm | ∘ | 135 MPa |
| invention | 52 | 0.7 | 0.1 | 0.2 | 0.2 | — | — | — | — | — | 2.0 | balance | 4045 | 50 mV | 49 μm | ∘ | 140 MPa |
| | 53 | 0.7 | 0.1 | 0.2 | 0.2 | — | — | 0.2 | 0.2 | 0.2 | — | balance | 4045 | 54 mV | 40 μm | ∘ | 142 MPa |
| | 54 | 0.8 | 0.06 | 0.2 | 0.2 | — | 0.1 | 0.2 | — | — | — | balance | 4045 | 52 mV | 48 μm | ∘ | 140 MPa |
| | 55 | 0.8 | 0.06 | 0.2 | 0.2 | — | 0.1 | 0.2 | 0.2 | 0.2 | 0.3 | balance | 4045 | 51 mV | 45 μm | ∘ | 147 MPa |
| | 56 | 0.8 | 0.1 | 0.2 | 0.2 | 0.4 | — | — | — | — | — | balance | 4045 | 56 mV | 44 μm | ∘ | 142 MPa |
| | 57 | 0.8 | 0.1 | 0.2 | 0.2 | 0.4 | — | 0.2 | 0.2 | 0.2 | — | balance | 4045 | 58 mV | 45 μm | ∘ | 147 MPa |
| | 58 | 0.8 | 0.06 | 0.4 | 0.4 | 0.8 | — | — | 0.2 | 0.2 | — | balance | 4045 | 52 mV | 36 μm | ∘ | 158 MPa |
| | 59 | 0.7 | 0.1 | 0.4 | 1.2 | 0.8 | — | — | 0.2 | — | — | balance | 4045 | 51 mV | 40 μm | ∘ | 155 MPa |
| | 60 | 1.2 | 0.1 | 0.4 | 0.4 | 0.8 | — | — | — | — | — | balance | 4045 | 62 mV | 32 μm | ∘ | 170 MPa |
| | 61 | 0.7 | 0.06 | 0.2 | 0.2 | 1.2 | — | — | — | — | — | balance | 4045 | 47 mV | 48 μm | ∘ | 158 MPa |
| | 62 | 0.8 | 0.1 | 0.4 | 0.4 | 0.8 | 0.1 | 0.2 | 0.2 | 0.2 | 0.3 | balance | 4045 | 55 mV | 29 μm | ∘ | 160 MPa |
| | 63 | 0.7 | 0.1 | 0.8 | 0.4 | 0.8 | 0.1 | — | — | 0.2 | — | balance | 4045 | 52 mV | 37 μm | ∘ | 143 MPa |
| | 64 | 0.8 | 0.2 | 0.4 | 0.4 | 0.8 | 0.1 | 0.2 | 0.2 | 0.2 | 0.3 | balance | 4045 | 60 mV | 25 μm | ∘ | 160 MPa |
| | 65 | 0.4 | 0.06 | 0.4 | 0.4 | 0.8 | 0.1 | 0.2 | 0.2 | — | — | balance | 4045 | 38 mV | 100 μm | ∘ | 130 MPa |
| | 66 | 0.8 | 0.1 | — | — | — | — | — | — | — | — | balance | 4045 + 0.1 | 67 mV | 34 μm | ∘ | 135 MPa |
| | | | | | | | | | | | | | wt % Sn | | | | |
| | 67 | 0.8 | 0.1 | 0.4 | 0.4 | 0.8 | 0.1 | 0.2 | — | — | — | balance | 4045 + 0.1 | 68 mV | 18 μm | ∘ | 152 MPa |
| | | | | | | | | | | | | | wt % Sn | | | | |
| | 68 | 0.8 | 0.1 | 0.4 | 0.4 | 0.8 | 0.1 | 0.2 | — | — | — | balance | 4045 + 0.2 | 73 mV | 19 μm | ∘ | 152 MPa |
| | | | | | | | | | | | | | wt % Sn | | | | |
| Comparative | 69 | 0.8 | — | — | — | — | — | — | — | — | — | balance | 4045 | 29 mV | Pierce | ∘ | 135 MPa |
| Example | 70 | 0.8 | — | 0.4 | 0.4 | 0.8 | 0.1 | 0.2 | — | — | — | balance | 4045 | 29 mV | Pierce | ∘ | 150 MPa |
| | 71 | 0.25 | 0.1 | — | — | — | — | — | — | — | — | balance | 4045 | 12 mV | Pierce | ∘ | 105 MPa |
| | 72 | 1.7 | 0.1 | — | — | — | — | — | — | — | — | balance | 4045 | 35 mV | Pierce | ∘ | 165 MPa |
| | 73 | 0.8 | 0.01 | 0.4 | 0.4 | 0.8 | 0.1 | 0.2 | — | — | — | balance | 4045 | 32 mV | Pierce | ∘ | 150 MPa |
| | 74 | 0.8 | 0.4 | 0.2 | 0.2 | 0.8 | 0.2 | — | — | — | — | balance | 4045 | — | — | x | — |
| | 75 | 0.8 | 0.1 | 0.2 | 0.2 | 0.8 | 0.2 | — | — | — | — | balance | 4045 + 0.4 | — | — | x | — |
| | | | | | | | | | | | | | wt % Sn | | | | |
| Conventional | 76 | 0.3 | — | 0.2 | 0.2 | 0.8 | 0.2 | — | — | — | — | balance | 4045 | 17 mV | Pierce | ∘ | 130 MPa |
| Example | 77 | 0.5 | — | 0.2 | 0.2 | 0.8 | 0.2 | — | — | — | — | balance | 4045 | 22 mV | Pierce | ∘ | 140 MPa |

(Note) —: No evaluation because a product could not given

As is apparent from the results shown in Table 3, in comparing the brazing sheets of the present invention with Comparative Examples and Conventional Examples, in the brazing sheets of the present invention, since the potential difference between the inside of the core alloy and the filler alloy surface is satisfactory, the corrosion resistance is excellent, and the rolling property and the strength are satisfactory.

Having described our invention as related to the present embodiments, it is our intention that the invention not be limited by any of the details of the description, unless otherwise specified, but rather be construed broadly within its spirit and scope as set out in the accompanying claims.

What we claimed is:

1. An aluminum alloy brazing sheet for constituting a fluid passage, which comprises an Al—Si-series filler alloy clad on one or both surfaces of an aluminum alloy core material comprising 0.3 to 1.5 wt % of Cu and 0.03 to 0.3 wt % of Sn, the balance of the alloy being substantially Al.

2. The aluminum alloy brazing sheet for constituting a fluid passage as claimed in claim 1, wherein the Al—Si-series filler alloy contains Sn in an amount of 0.03 to 0.3 wt %.

3. The aluminum alloy brazing sheet for constituting a fluid passage as claimed in claim 1, wherein the aluminum alloy core material contains Cu in an amount of 0.5 to 1.0 wt %.

4. The aluminum alloy brazing sheet for constituting a fluid passage as claimed in claim 1, wherein the Al—Si-series filler alloy does not contain Sn.

5. The aluminum alloy brazing sheet for constituting a fluid passage as claimed in claim 1, wherein the filler alloy is clad on one or both surface of the core alloy, with the clad ratio in the range of 5 to 30% for the whole plate thickness.

6. The aluminum alloy brazing sheet for constituting a fluid passage as claimed in claim 1, wherein a final thickness of the aluminum alloy brazing sheet is 0.2 to 1.2 mm.

7. The aluminum alloy brazing sheet for constituting a fluid passage as claimed in claim 1, wherein the brazing sheet is at least one of the material selected from the group consisting of an evaporator plate material, a radiator tube material, a header plate material and a tank material.

8. An aluminum alloy brazing sheet for constituting a fluid passage, which comprises an Al—Si-series filler alloy clad on one or both surfaces of an aluminum alloy core material comprising Cu in an amount of 0.3 to 1.5 wt %, Sn in an amount of 0.03 to 0.3 wt %, and at least one element selected from the group consisting of Si in an amount of 1.2 wt % or less, Fe in an amount of 2.0 wt % or less, Mn in an amount of 2.0 wt % or less, Ti in an amount of 0.3 wt % or less, Mg in an amount of 1.0 wt % or less, Cr in an amount of 0.5 wt % or less, Zr in an amount of 0.5 wt % or less, and Zn in an amount of 2.0 wt % or less, the balance of the alloy being substantially Al.

9. The aluminum alloy brazing sheet for constituting a fluid passage as claimed in claim 8, wherein the Al—Si-series filler alloy contains Sn in an amount of 0.03 to 0.3 wt %.

10. The aluminum alloy brazing sheet for constituting a fluid passage as claimed in claim 8, wherein the aluminum alloy core material contains Cu in an amount of 0.5 to 1.0 wt %.

11. The aluminum alloy brazing sheet for constituting a fluid passage as claimed in claim 8, wherein the Al—Si-series filler alloy does not contain Sn.

12. The aluminum alloy brazing sheet for constituting a fluid passage as claimed in claim 8, wherein the aluminum alloy core material contains at least one of Si in an amount of 0.05 to 1.0 wt %, Fe in an amount of 0.05 to 1.0 wt %, Mn in an amount of 0.4 to 1.5 wt %, Ti in an amount of 0.1 to 0.2 wt %, Mg in an amount of 0.1 to 0.3 wt %, Cr in an amount of 0.05 to 0.25 wt %, Zr in an amount of 0.05 to 0.25 wt %, and Zn in an amount of 0.1 to 1.0 wt %.

13. The aluminum alloy brazing sheet for constituting a fluid passage as claimed in claim 8, wherein the filler alloy is clad on one or both surface of the core alloy, with the clad ratio in the range of 5 to 30% for the whole plate thickness.

14. The aluminum alloy brazing sheet for constituting a fluid passage as claimed in claim 8, wherein a final thickness of the aluminum alloy brazing sheet is 0.2 to 1.2 mm.

15. The aluminum alloy brazing sheet for constituting a fluid passage as claimed in claim 8, wherein the brazing sheet is at least one of the material selected from the group consisting of an evaporator plate material, a radiator tube material, a header plate material and a tank material.
